(19) United States
(12) Patent Application Publication
(10) Pub. No.: US 2019/0324130 A1
(43) Pub. Date: Oct. 24, 2019

(54) SENSOR SYSTEM

(71) Applicant: KOITO MANUFACTURING CO., LTD., Tokyo (JP)

(72) Inventors: Teruaki Yamamoto, Shizuoka-shi (JP); Naoki Takii, Shizuoka-shi (JP); Akitaka Kanamori, Shizuoka-shi (JP)

(73) Assignee: KOITO MANUFACTURING CO., LTD., Tokyo (JP)

(21) Appl. No.: 16/389,231

(22) Filed: Apr. 19, 2019

(30) Foreign Application Priority Data
Apr. 20, 2018 (JP) 2018-081310

(51) Int. Cl. G01S 7/497; G01S 7/481; G01S 17/93

(52) U.S. Cl. CPC G01S 7/497; G01S 17/936; G01S 7/481

(57) ABSTRACT

A sensor unit is configured to sense external information of the vehicle. A temperature adjusting section is configured to perform temperature adjustment of the sensor unit. An information acquiring section is configured to acquire identification information of a user while an engine of the vehicle is stopped. A control section is configured to cause the temperature adjusting section to initiate the temperature adjustment in response to acquisition of the identification information.

### TECHNICAL FIELD

The presently disclosed subject matter relates to a sensor system adapted to be mounted on a vehicle.

### BACKGROUND ART

In order to realize the driving support technology of the vehicle, sensors for sensing external information of the vehicle shall be mounted on a vehicle body. Examples of such sensors include LiDAR (Light Detection and Ranging sensors and cameras (see, e.g., Patent Document 1).

### PRIOR ART DOCUMENT

### Patent Document

Patent Document 1: Japanese Patent Publication No. 2010-185769A

### SUMMARY

There is an appropriate operating temperature range for these sensors to provide reliable sensed results. In cold or intense hot regions, the sensor may fall outside of the proper operating temperature range while the engine is stopped. In such a case, even if the engine is activated, the driving support operation with the sensor cannot be initiated until the sensor falls within the proper operating temperature range.

It is thus demanded to shorten the time until the driving assistance operation is initiated.

In order to meet the demand described above, an illustrative aspect of the presently disclosed subject matter provides a sensor system adapted to be mounted on a vehicle, comprising:
a sensor unit configured to sense external information of the vehicle;
a temperature adjusting section configured to perform temperature adjustment of the sensor unit;
an information acquiring section configured to acquire identification information of a user while an engine of the vehicle is stopped; and
a control section configured to cause the temperature adjusting section to initiate the temperature adjustment in response to acquisition of the identification information.

According to this configuration, before the user activates the engine, it is possible to initiate the temperature adjustment for causing the sensor unit to fall within the proper operating temperature range. Therefore, it is possible to shorten the time from the activation of the engine to the initiation of the driving support operation with the sensor unit.

The above sensor system may be configured such that the information acquiring section is configured to acquire the identification information with radio waves.

According to such a configuration, the temperature adjustment by the temperature adjusting section can be initiated before the engine is activated with a relatively simple configuration.

Alternatively, the above sensor system may be configured such that the information acquiring section is configured to acquire the identification information with face authentication.

According to such a configuration, the temperature adjustment by the temperature adjusting section can be initiated before the engine is activated while the security is enhanced.

The above sensor system may be configured such that the temperature adjusting section includes a heat transferring member configured to transfer heat generated from the engine to the sensor unit.

According to such a configuration, the remaining heat generated even during the stoppage of the engine can be used to warm the sensor unit. Therefore, particularly in the case where the vehicle is in a low-temperature environment, it is possible to shorten the time from the activation of the engine to the initiation of the driving support operation with the sensor unit.

The above sensor system may further comprise:
a lamp unit configured to emit visible light;
a lamp housing defining a lamp chamber for accommodating the lamp unit; and
a partition wall defining an accommodation space in the lamp chamber.
   Here, the sensor unit is disposed in the accommodation space.

According to such a configuration, it is possible to suppress the influence of the heat generated from the lamp unit on the sensor unit. In addition, since the sensor unit is disposed in the accommodation space that is relatively restricted, the temperature control by the temperature control section can be facilitated. Therefore, it is possible to easily shorten the time from the activation of the engine to the initiation of the driving support operation with the sensor unit.

The above-described configurations are particularly advantageous in a case where the sensor unit is a LiDAR sensor unit the operating temperature condition of which is relatively strict.

In the present specification, the term “sensor unit” means a constituent unit of a component that can be distributed by itself as a single unit while providing a desired information sensing function.

In the present specification, the term “lamp unit” means a constituent unit of a component that can be distributed by itself as a single unit while providing a desired lighting function.

In the present specification, the term “driving support” means control processing that at least partially performs at least one of driving operation (steering operation, acceleration, deceleration), monitoring of a driving environment, and backup of driving operation. That is, it includes not only the partial driving support such as braking function for collision avoidance and assisting function for lane-keeping, but also a full self-driving operation.

### BRIEF DESCRIPTION OF THE DRAWINGS

FIG. 1 illustrates a configuration of a sensor system according to one embodiment is to be mounted.

FIG. 2 illustrates a left front lamp device on which the sensor system is mounted.

FIG. 3 illustrates a position of the sensor system in a vehicle.

### DESCRIPTION OF EMBODIMENTS

Examples of embodiments will be described below in detail with reference to the accompanying drawings. In each of the drawings used in the following descriptions, the scale is appropriately changed in order to make each of the members have a recognizable size.

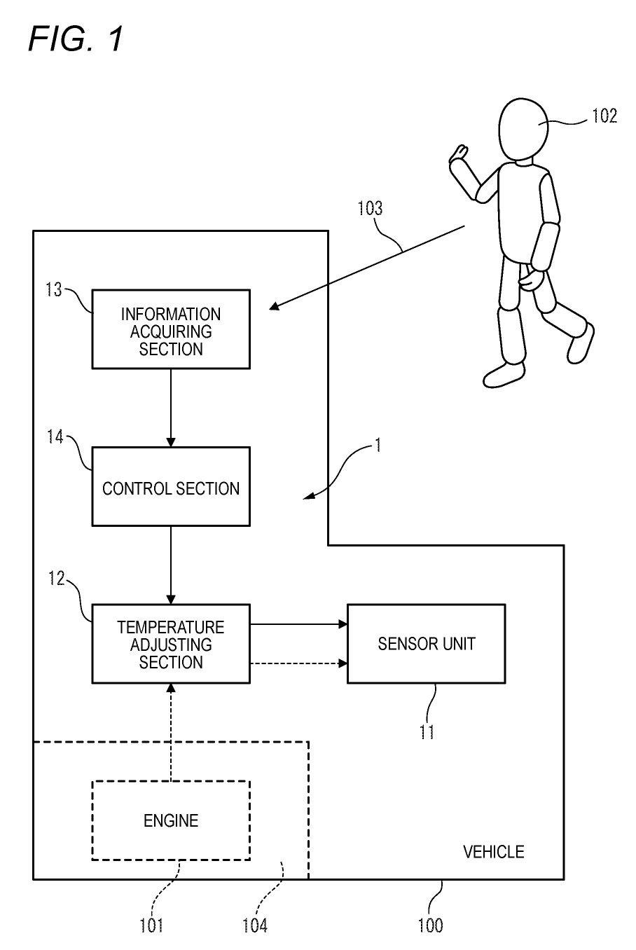

FIG. 1 schematically illustrates a configuration of a sensor system 1 according to a first embodiment. The sensor system 1 is mounted on a vehicle 100.

The sensor system 1 includes a sensor unit 11. The sensor unit 11 is a device that senses external information of the vehicle 100 and outputs a signal corresponding to the sensed information. The sensor unit 11 may be any of a LiDAR sensor unit, a camera unit, and a millimeter wave sensor unit.

The LiDAR sensor unit has a configuration for emitting non-visible light and a configuration for sensing returned light as a result of the non-visible light being reflected by at least an object existing outside the vehicle 100. As required, the LiDAR sensor unit may include a scan device that sweeps the non-visible light to change the light emitting direction (i.e., the sensing direction). For example, infrared light having a wavelength of 905 nm is used as the non-visible light.

The LiDAR sensor unit can obtain the distance to the object associated with the returned light, for example, based on the time period from the time when the non-visible light is emitted in a certain direction to the time when the returned light is sensed. Further, by accumulating such distance data in association with the sensing position, it is possible to obtain information as to the shape of the object associated with the returned light. Additionally or alternatively, information as to an attribute such as the material of the object associated with the returned light can be obtained based on the difference in wavelength between the emitted light and the returned light.

The camera unit is a device for acquiring an image as the external information of the vehicle. The image may include at least one of a still image and a moving image. The camera unit may include a camera sensitive to visible light or a camera sensitive to infrared light.

The millimeter wave sensor unit has a configuration for transmitting a millimeter wave and a configuration for receiving a reflected wave as a result of the millimeter wave being reflected by an object existing outside of the vehicle 1. Examples of frequencies of the millimeter wave include 24 GHz, 26 GHz, 76 GHz, 79 GHz, etc. The millimeter wave sensor unit can obtain the distance to the object associated with the reflected wave, for example, based on the time period from the time when the millimeter wave is transmitted in a certain direction to the time when the reflected wave is received. Further, by accumulating such distance data in association with the sensing position, it is possible to obtain information as to the shape of the object associated with the reflected wave.

The sensor unit 11 as described above has an appropriate operating temperature range. The appropriate operating temperature range is defined as the operating temperature range at which the sensor unit 11 can sense information with sufficient reliability.

The sensor system 1 includes a temperature adjusting section 12. The temperature adjusting section 12 is configured to adjust the temperature of the sensor unit 11. Specifically, the temperature adjusting section 12 performs temperature adjustment so that the temperature of the sensor unit 11 falls within an appropriate operating temperature range. The temperature can be adjusted by a warming device such as a heater, a cooling device such as a fan and a Peltier element.

The sensor system 1 includes an information acquiring section 13. The information acquiring section 13 is configured to acquire identification information 103 of the user 102 while the engine 101 of the vehicle 100 is stopped.

The sensor system 1 includes a control section 14. When the information acquiring section 13 acquires the identification information 103, the control section 14 causes the temperature adjusting section 12 to initiate temperature adjustment of the sensor unit 11.

According to this configuration, before the user 102 activates the engine 101, it is possible to initiate the temperature adjustment for causing the sensor unit 11 to fall within the proper operating temperature range. Therefore, it is possible to shorten the time from the activation of the engine 101 to the initiation of the driving support operation with the sensor unit 11.

As an example, the identification information 103 may be acquired using radio waves. In this case, the user 102 may possess a smart key or a portable information terminal that emits radio waves including the identification information 103. The information acquiring section 13 may be configured to receive the radio wave. When the intensity of the radio wave exceeds a predetermined value, the control section 14 determines that the user 102 is approaching the vehicle 100, and causes the temperature adjusting section 12 to initiate the temperature adjustment.

According to such a configuration, the temperature adjustment by the temperature adjusting section 12 can be initiated before the engine 101 is activated with a relatively simple configuration.

As another example, the identification information 103 may be obtained using face authentication. In this case, the information acquiring section 13 may include a camera and a processor capable of performing the face authentication processing. The user 102 needs to register his/her face information to be used for the face authentication in advance. When the information acquiring section 13 recognizes the user 102 approaching the vehicle 100, the control section 14 causes the temperature adjusting section 12 to initiate the temperature adjustment.

According to such a configuration, the temperature adjustment by the temperature adjusting section 12 can be initiated before the engine 101 is activated while the security is enhanced.

The information acquiring section 13 may acquire the identification information 103 of the user 102 through voice authentication, fingerprint authentication, remote operation by a portable terminal, or the like.

At least a part of the functions of the information acquiring section 13 and the control section 14 described above can be implemented by at least one processor and at least one memory. Examples of the processor include a CPU an MPU, and a GPU. The processor may include multiple processor cores. Examples of the memory include ROM and RAM. The ROM can store a program for implementing the above-mentioned functions. The processor may specify at least a part of the program stored in the ROM, load the program on the RAM, and implement the above functions in cooperation with the RAM.

At least a part of the functions of the information acquiring section 13 and the control section 14 may be implemented by at least one hardware resource (e.g., an integrated circuit such as an ASIC or an FPGA) that differs from the above-described processor and memory.

As indicated by dashed lines in FIG. 1, the temperature adjusting section 12 may include a heat transferring member 12a that transfers heat generated from the engine 101 to the sensor unit 11.

As the heat transferring member 12a, a heat pipe may be exemplified. In this case, one end of the heat pipe is connected to the engine 101 or a heat sink provided in an engine compartment 104. The other end of the heat pipe is connected to the sensor unit 11.

According to such a configuration, the remaining heat generated even during the stoppage of the engine 101 can be used to warm the sensor unit 11. Therefore, particularly in the case where the vehicle 100 is in a low-temperature environment, it is possible to shorten the time from the activation of the engine 101 to the initiation of the driving support operation with the sensor unit 11.

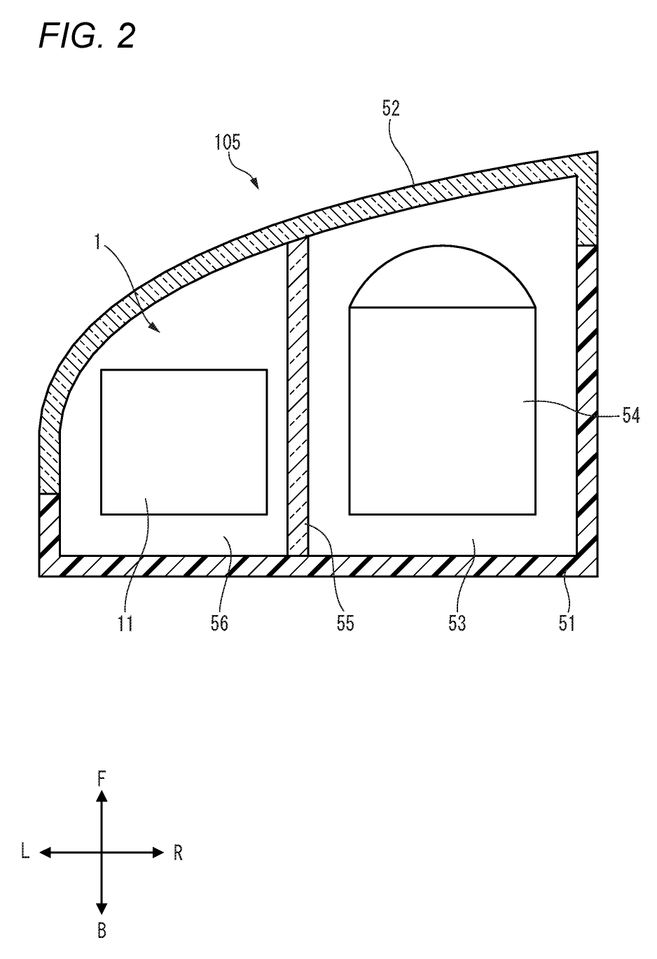

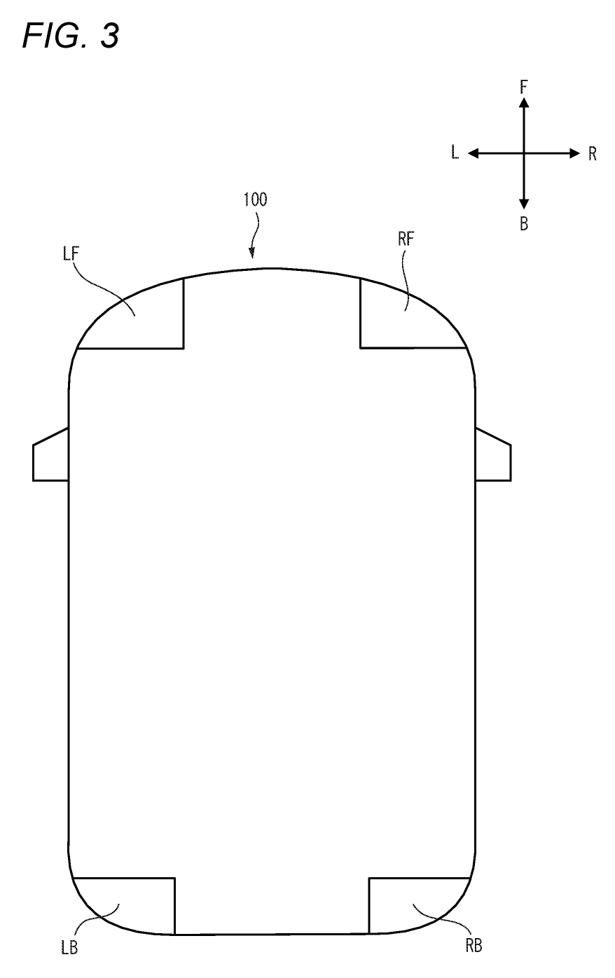

Referring to FIG. 2 and FIG. 3, a case where the sensor system 1 is mounted on a left front lamp device 105 will be described. In these figures, an arrow F represents a forward direction of the illustrated structure. An arrow B represents a rearward direction of the illustrated structure. An arrow L represents a leftward direction of the illustrated structure. An arrow R represents a rightward direction of the illustrated structure. The terms of “left” and “right” used in the following descriptions indicate the left-right directions as viewed from the driver's seat.

FIG. 2 schematically shows the configuration of the left front lamp device 105. In the drawing, the temperature adjusting section 12, the information acquiring section 13, and the control section 14 are not shown. The left front lamp device 105 includes a lamp housing 51 and a translucent cover 52. The lamp housing 51 and the translucent cover 52 define a lamp chamber 53. The left front lamp device 105 is mounted on a left front corner LF of the vehicle 100 shown in FIG. 3. A right front lamp device having a configuration symmetrical with the left front lamp device 105 relative to the left-right direction is mounted on a right front corner portion RF of the vehicle 100.

As shown in FIG. 2, the left front lamp device 105 includes a lamp unit 54. The lamp unit 54 is a device that emits visible light to the outside of the vehicle 100. The lamp unit 54 is accommodated in the lamp chamber 53. Examples of the lamp unit 54 include a headlamp unit, a clearance lamp unit, a direction indicator lamp unit, and a fog lamp unit.

The left front lamp device 105 includes a partition wall 55. The partition wall 55 defines an accommodation space 56 for the sensor unit 11 in the lamp chamber 53. The sensor unit 11 is disposed in the accommodation space 56.

According to such a configuration, it is possible to suppress the influence of the heat generated from the lamp unit 54 on the sensor unit 11. In addition, since the sensor unit 11 is disposed in the accommodation space 56 that is relatively restricted, the temperature control by the temperature control section 12 can be facilitated. Therefore, it is possible to easily shorten the time from the activation of the engine 101 to the initiation of the driving support operation with the sensor unit 11.

As described above, the sensor unit 11 may be any of a LiDAR sensor unit, a camera unit, and a millimeter wave sensor unit. However, the above-described configurations are particularly advantageous in a case where the sensor unit 11 is a LiDAR sensor unit the operating temperature condition of which is relatively strict. In this instance, from the viewpoint of the effectiveness of the temperature adjustment, it is preferable that the warming or cooling by the temperature adjusting section 12 is performed on at least one of the configuration for emitting the non-visible light in the LiDAR sensor unit and the mechanism for sweeping the non-visible light.

The above embodiments are merely examples for facilitating understanding of the gist of the presently disclosed subject matter. The configuration according to each of the above embodiments can be appropriately modified or improved without departing from the gist of the presently disclosed subject matter.

The configuration of the left front lamp device 105 is also applicable to a left rear lamp device. The left rear lamp device is mounted in a left rear corner LB of the vehicle 100 shown in FIG. 3. The basic configuration of the left rear lamp device may be symmetrical with respect to the left front lamp device 105 relative to the front-rear direction.

The configuration of the left front lamp device 105 is also applicable to a right rear lamp device. The right rear lamp device is mounted in a right rear corner RB of the vehicle 100 shown in FIG. 3. The basic configuration of the right rear lamp device is symmetrical with respect to the above-mentioned left rear lamp device relative to the left-right direction.

The present application is based on Japanese Patent Application No. 2018-081310 filed on Apr. 20, 2018, the entire contents of which are incorporated herein by reference.

1. A sensor system adapted to be mounted on a vehicle, comprising:
a sensor unit configured to sense external information of the vehicle;
a temperature adjusting section configured to perform temperature adjustment of the sensor unit;
an information acquiring section configured to acquire identification information of a user while an engine of the vehicle is stopped; and
a control section configured to cause the temperature adjusting section to initiate the temperature adjustment in response to acquisition of the identification information.

2. The sensor system according to claim 1,
wherein the information acquiring section is configured to acquire the identification information with radio waves.

3. The sensor system according to claim 1,
wherein the information acquiring section is configured to acquire the identification information with face authentication.

4. The sensor system according to claim 1,
wherein the temperature adjusting section includes a heat transferring member configured to transfer heat generated from the engine to the sensor unit.

5. The sensor system according to claim 1, further comprising:
a lamp unit configured to emit visible light;
a lamp housing defining a lamp chamber for accommodating the lamp unit; and
a partition wall defining an accommodation space in the lamp chamber,
wherein the sensor unit is disposed in the accommodation space.

6. The sensor unit according to claim 1,
wherein the sensor unit is a LiDAR sensor unit.
